(19) United States
(12) Patent Application Publication
(10) Pub. No.: US 2016/0049083 A1
(43) Pub. Date: Feb. 18, 2016

(54) SYSTEMS AND METHODS FOR AUTHORING AN INTEGRATED AND INDIVIDUALIZED COURSE OR TEXTBOOK

(71) Applicant: Zoomi, Inc., Malvern, PA (US)

(72) Inventors: Christopher Greg Brinton, Berkeley Heights, NJ (US); Mung Chiang, Princeton, NJ (US); Sangtae Ha, Superior, CO (US); William D. Ju, Mendham, NJ (US); Stefan Rudiger Rill, Augsburg (DE); James Craig Walker, Chester Springs, PA (US)

(21) Appl. No.: 14/829,202

(22) Filed: Aug. 18, 2015

Related U.S. Application Data
(63) Continuation of application No. PCT/US15/45063, filed on Aug. 13, 2015.
(60) Provisional application No. 62/038,814, filed on Aug. 18, 2014.
(60) Provisional application No. 62/038,814, filed on Aug. 18, 2014.

(51) Int. Cl. G09B 5/12; G09B 7/00

(52) U.S. Cl. CPC G09B 5/12; G09B 7/00

(57) ABSTRACT

The present invention is directed towards methods and systems to assist an author in constructing an electronic course or textbook (referred to generally as a course). The system allows an author to integrate various types of content into his/her course, and to specify a set of rules that will determine if and how the content will be individualized to each end user; the resultant courses are thus termed Integrated and Individualized Courses (IIC). Through the system, an author is able to import content files into an authoring application, and then use this application to edit the files, arrange them into segments, and define the course structure as a sequence of these segments, all through drag and drop functionality.

This application claims priority to U.S. Provisional Patent Application No. 62/038,814, presently pending and filed Aug. 18, 2014 and is a continuation of PCT/US15/45063, presently pending and filed Aug. 13, 2015, which also claims priority to U.S. Provisional Patent Application No. 62/038,814, filed Aug. 18, 2014, all incorporated herein by reference.

### TECHNICAL FIELD OF THE INVENTION

The present application relates to systems and methods for assisting authors and other course creators in creating electronic courses or textbooks. The present invention is of particular utility in circumstances in which an author seeks to have individualized content delivered, where the delivered content is based on a user model, and in which there are various types of content to be integrated into the course.

### BACKGROUND OF THE INVENTION

There have been recent attempts at creating adaptive courses and textbooks that can change delivered content dynamically based on the attributes of a specific user. For purposes of adaptation, these methods will generally define, and continually update a user model based on different inputs that are collected about the user and subsequently analyzed, but may differ widely in the specific types and granularity at which these inputs are measured and leveraged.

Due to the potential complexities in the user model, as well as the various types of content and/or modalities of learning that the author may desire to integrate into the course, the process of converting initial content to a final adaptive course becomes cumbersome for both the content author and the course provider. It requires, at minimum, the conversion of the different content files into a form suitable for the target platform, the tagging of different parts of the content with unique identifiers to indicate how those parts relate to the user model, and the construction of large rule sets that specify both how to transition between segments of content and how the segments themselves should adapt depending on the current user model.

Therefore, it is desirable to design a system that can assist in the authoring process of such a course or textbook.

### BRIEF DESCRIPTION OF THE INVENTION

This disclosure pertains to an invention for an automated tool or series of tools that can be used by an author to structure a set of static or dynamic content segments into an adaptive course or textbook (referred to generally as “course”), whereby the content of the course may change for each individual depending on an overlaid specified user model. Such a model is one of several that is concurrently implemented and each reflects association of different content elements based on a user profile, a user's (student's) progress, determined proficiency, or inferred learning style preferences through a course or some combination. Part of the present invention consists of a Graphical User Interface (GUI) to be used at an author workstation, which supports the functions necessary to create this type of course, including content importing, segmenting, tagging, and adaptation rule-set specification.

The present invention places no limitation on the type (aka “medium”, e.g., textbook, video, slides, multimedia) or file format of content that can be included in the target course, thereby supporting the integration of various learning modalities. As a result, we term the target courses Integrated and Individualized Courses (IIC), though an author could just as well use the present invention to create a course that is neither integrated (i.e., only one content type) nor individualized. The invention includes a method to compile an IIC into a file format compatible with target end user devices, and a method to ultimately deliver the course to those devices.

By completely eliminating the need for a third party to intervene between course authoring and final production, the present invention makes the process of adaptive course creation more convenient for both the author and the platform provider. It is in many ways analogous to the effect that word processors have on the creation of documents, or to the effect that slideshow editors have on the creation of presentations.

### BRIEF DESCRIPTION OF THE FIGURES

FIG. 1 depicts a schematic diagram of the layout of the system components involved in the process of authoring and rendering an IIC.

FIG. 2 is a depiction of the main graphical user interface by which an author will construct an IIC, in a preferred embodiment of the present invention.

FIG. 3 depicts the method of feature tagging and answer choice point specifications for a video file and an assessment file, respectively.

FIG. 4 depicts the method of specifying rules that dictate presentation adaptation within a segment of the IIC, for a text file and a video file, respectively.

FIG. 5 depicts the method of specifying rules that dictate adaptive navigation between segments of the IIC.

FIG. 6 depicts the process of an author creating linkages for content in the context of the present invention.

FIG. 7 depicts an embodiment of the structure of an IIC index file.

FIG. 8 depicts a graphical user interface of a sample map of a course structure with all pathways a user can take following the different behavioral transitions that are available.

### DETAILED DESCRIPTION OF THE INVENTION

The present invention is directed to assist an author in constructing an electronic course or textbook (referred to generally as a course). The system allows an author to integrate various types of content into his/her course, and to specify a set of rules that will determine if and how the content will be individualized to each end user; the resultant courses are thus termed Integrated and Individualized Courses (IIC).

Through the system, an author is able to import content files into an authoring application, and then use this application to edit the files, arrange them into segments, and define the course structure as a sequence of these segments, all preferably through drag and drop functionality. Further, the system supports the tagging of content pieces to specify how a user model is updated, and also the definition of rule sets to determine how the content is adapted based on the current user model, where the user model tracks a user's tendency towards, and/or proficiency with, a set of author-specified learning features. The present invention performs this tracking in real-time as the user interacts with the IIC, using adaptive machine learning techniques, which are described herein. Using this tracking data, the machine learning customizes the sequence and the content delivery to a particular student for an IIC in real time.

The present invention is further directed to an authoring tool for an author to create or amend an on-line (or other) course, such that the author can identify, relate, and associate different forms of content, configured to be displayed to a user (student) in one or more particular sequences, where the sequence and actual content may differ based on the student, such as but not limited to based on the determined proficiency and/or learning style of a particular student.

This invention also includes a method of identifying a target device and compiling the IICs into a file format compatible with, and ultimately delivering the courses to the target devices.

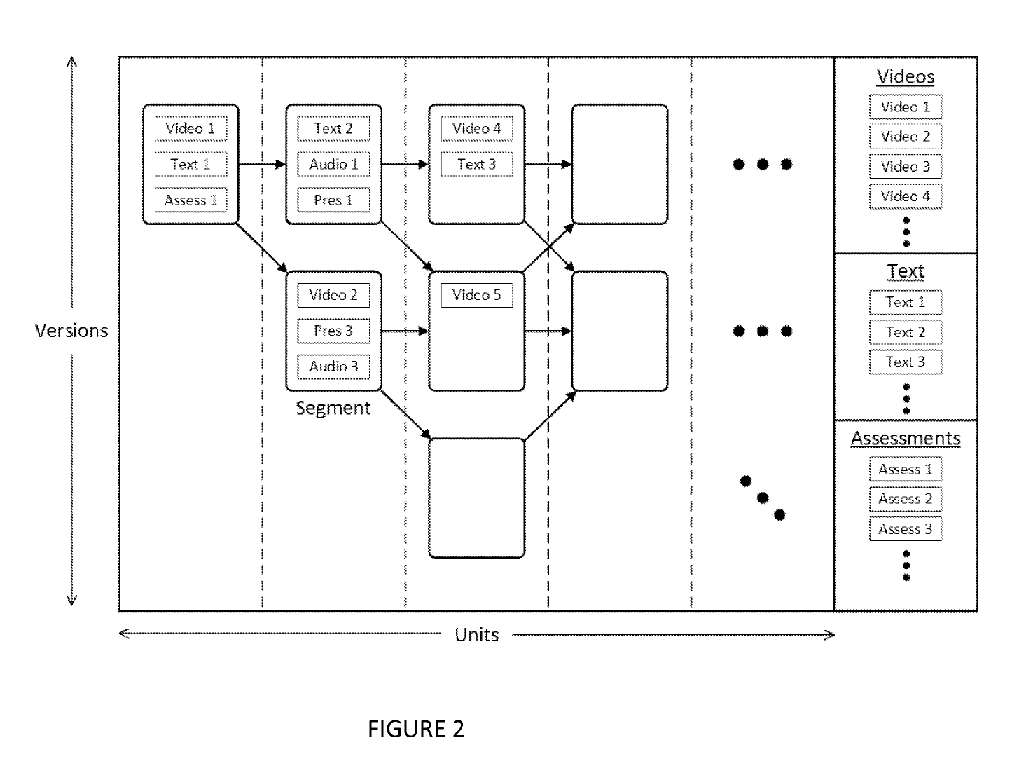

The present invention is broadly directed to a tool and method for course creation, where the course is customized during delivery based on, for example, a student's progress and/or determined proficiency. In the method of the present invention, an author initially amasses content for a course, and arranges the content in a logical fashion of his/her choosing, such as but not limited to defined topical areas in a syllabus. As depicted in FIG. 2, the course could be subdivided into units, with each unit representing a portion of the course's syllabus, each unit in turn being further subdivided into segments, corresponding to various and varying content delivery for the unit. For example, within a unit, different segments could correspond to different learning styles, different levels of difficulty, or different levels of detail in which the content for the unit is explained. It is possible for a unit to only have one segment as well.

Note that the segments need not be grouped into specific units, as is shown in FIG. 2; this arrangement is available simply for convenience in guiding the author's construction of the adaptive course.

The content for the course may be created by the author or through some other source. The content is maintained in different electronic files and potentially different file types, including but not limited to text, video, audio, slides, and visuals. Note that in an IIC, content comes in two broad types: material files, i.e., those that are meant to deliver information to the user, and assessment files, i.e., those that are meant to test user proficiency with the material. Note that assessment files may contain multiple questions testing a user's proficiency with the content. At least some of these may be interactive, in the sense that the user (student) may be asked to respond to queries or provide data in a proactive way. In addition, for all content files, a student's interaction with the file is tracked. Each file is referred to herein as a “content file”, and an author can assign any number of content files, of the same or of different types, to a segment. One or more files which relate to one or more particular portions of a course are referred to as “a learning module”.

In examples, one or more content files may be associated with a single assessment file, there could be a one-for-one correspondence, or there might be different assessment files based on different assessment results. It is up to the author to establish these relationships for a course.

In the method of the present invention, the author “tags” each content file and/or portions of content files with descriptive indicators, or learning features. At least some of these tags may be identified automatically by the system of the present invention, such as by voice or text recognition. These features comprise the different dimensions of the user model, which is later updated based on measurements collected about the user as he/she interacts with the corresponding course content. Such tagging may be based on a plurality of factors such as, for example, on the detail level of descriptive content.

Even if tagging is automatic, an author may still have the opportunity to review and amend tags.

In the context of the present invention, the learning features will be author-specified. In a preferred embodiment, there are two types: learning concept features, which are the key topics by which the course is delivered, and learning style features, which are different ways in which the content can be delivered to the user. For example, in a course on Calculus, some of the learning concept features could be rules for differentiation, rules for integration, limits, and so forth, while the learning style features could be visual, verbal, auditory, kinesthetic, and other ways of explaining the material, or the exhibition of certain behavioral patterns like tendency to revise content multiple times, or tendency to skip over content. A purpose of at least some tags is to identify content so as to facilitate a mapping between a specific file, or portion of a content file, and these learning features; for example, if a specific section of a video file corresponds to “rules for integration” explained in both “visual” and “auditory” styles, the content can be tagged as such by the author. Tracking user interaction with the portion of the content file that contains this tag will then lead to measurements used to update the user model on these respective dimensions.

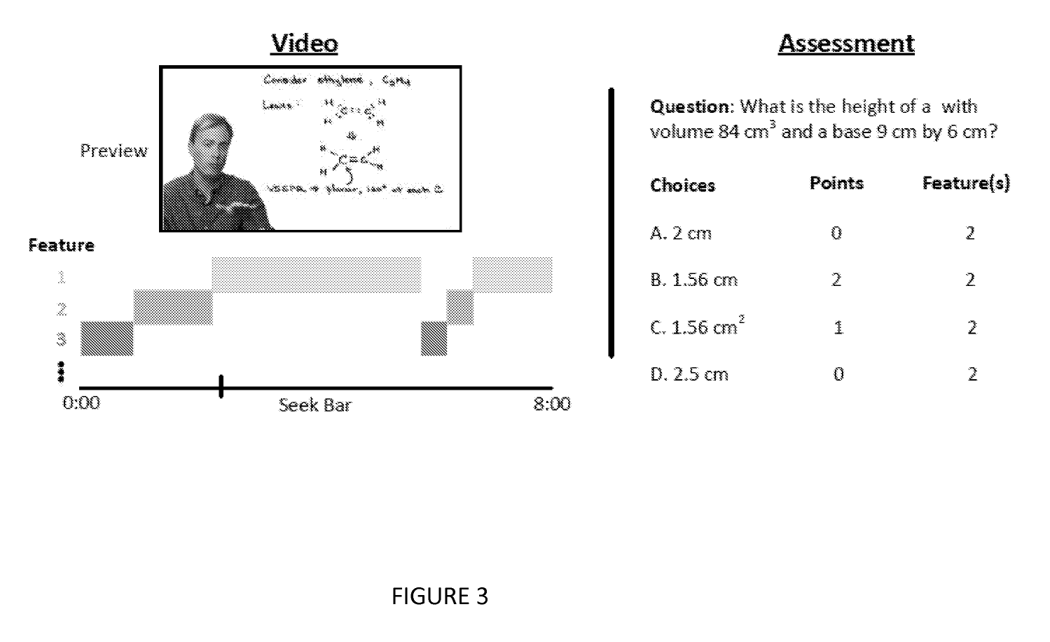

In the present invention, tagging may work differently for different types of content. For slide presentations there may be tags for the entire presentation, and each slide (or a group of slides) can receive one or more tag. For audio and video files, each can receive one or more tag, and can have tags for specific intervals; so 0:15 to 1:30 may have one tag, while 2:00 to 3:30 has another. Note that there could be a single tagging (with one or more tags) for the entire file. Text documents work similarly to audio and video, except the intervals would correspond to lines of the text (e.g., lines 10 to 50 receive one tag, lines 60 to 100 get another). Finally, each question in each assessment should have a single tag when it is directed to one learning concept, i.e., one question tests one learning concept, which is specified in the tag it is given. FIG. 3 shows an example of tagging for a video and an assessment file.

Note, however, that the present invention places no limitation on the types of content that can be integrated and tagged, as these specifications can serve as general cases for similar file formats as well; for example, other forms of multimedia can be treated as “video/audio” files, with specific lengths tagged, or as “text”, with specific locations on the page tagged.

Automated tagging can be implemented using a set of rules. The rules can be established by the author, such as by identifying keywords to be recognized in a search.

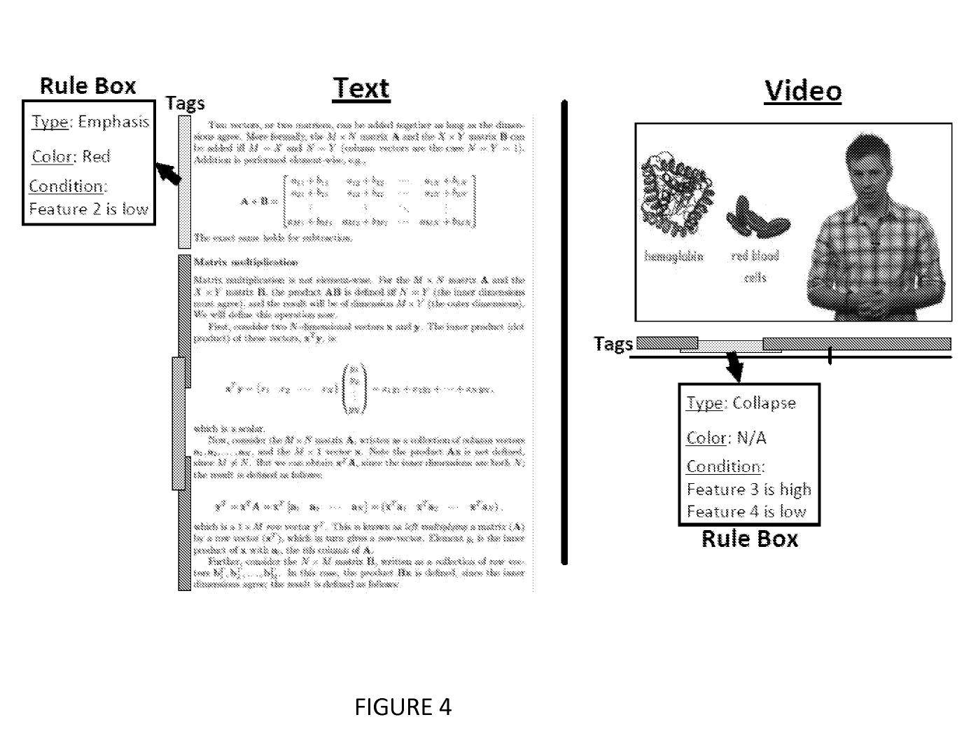

An author constructs segments by amassing content files prepared for and intended to be presented to a user viewing that segment in one form or another, typically in a specified sequence. The specified sequence is developed conformant to a user model. In applying tags to the content files, the author is implicitly specifying how the user model will be updated when a user visits the segment. The sequence of segments that a user visits, as well as the specific order and/or subsets of each content file within a segment that are presented, may differ for two different users taking the course, in one or multiple ways. The exact sequence of segments and the customization of the files within each segment are determined by a comparison between the current state of the user model and a number of decision rules specified by the author through the aid of the present invention. Each rule will impose a constraint on one or more of the learning features making up the user model. These rules are used to formulate different types of flow through a segment and between segments, so as to accommodate the needs of different types of students. Each feasible sequence of segments and segment variations is a different “learning path” through the course, and each learning path corresponds to a different type of student. A student's learning path is determined by a set of decision rules that are specified by the author through the aid of the present invention. An example of decision rules, and an embodiment of the graphical interface supporting the creation of such rules, is shown in FIG. 4.

The author also will retain the ability to swap out content over time. For example, if assessment results after one delivered content file are often poor, the system can inform the author, who can revise or replace the content or assessment file. In another example, an author can use on-going assessment results to prepare an alternate set of content for upcoming students, where the alternate set may be developed by the author to emphasize the areas where students had scored poorly.

The author will keep in mind the range of learning behavior that the course will accommodate in constructing the decision rules, and can think about grouping certain user models together to receive the same learning path. For example, one path may be applicable to all students who absorb information quickly, another for a more deliberate student, and so on. Given that each unit is representative of a different portion of the syllabus, the segments in a particular unit should collectively cover all different groups of user models, which would ensure that each group experiences a different learning path; however, this constraint is not a requirement and depends on the author's preferences.

Said another way, once a segment's content is established, the author creates linkages between content files (and/or portions of the files) in a segment by setting up a sequence of tagged information. Further, the author sets up the sequence relative to one or more user models. That is, in the system of the present invention, tagged pieces of content may be further identified based on some characteristics, such as difficulty or approach and, for any given segment, different flows based on differing user models may be created by the author. The author then identifies relationships between segments, such as identifying the sequence of delivery of segments and determination of completion of segments and, potentially, transitions between segments so as to complete development of the course. In the system of the present invention, a user can flow through a course in a variety of ways, such as completing the course using a unitary user model or varying from the default user model based on the user's known attributes (such as, for example, a different capability level for math than for philosophical elements). Further, once the course is fully implemented, in the applicable IICs, the particular sequence may vary from the applicable user model based on how a student progresses through the material. That is, in the present invention, the system of the present invention includes its own adaptive learning so as to customize the course on a user-by-user basis.

A system that automates the process of content tagging can also be envisioned. In this case, learning style tags could simply correspond to the different file types (e.g., video is one style, text is another, and so forth). Content tags could be determined by taking a textual representation of each file (e.g., a transcript of a video, or the actual text in any article file), and extracting the latent learning features from this collection of text by applying a standard topic extraction algorithm such as Latent Dirichlet Allocation (LDA), which will return a set of course topics, as well as the document-topic associations (a “document” is some partition of the collection of text, e.g., each sentence). LDA is a generative probabilistic model that can identify topics in documents or blocks of text using natural language processing. In LDA, each document is modeled as a certain combination of topics (each has a different mixture of topics), and each topic is modeled as a certain combination of words (again, each a different mixture). Under these model assumptions, the set of topics (in terms of constituent words) that best represent the collection of text can be reverse engineered. Each portion of each file could then be tagged, such as by matching to syllabus keywords, with the topics that are most representative of that portion, by analyzing the document-topic associations. The downside of this approach is that the author would not have control over the set of topics that are extracted.

In summary, the present invention includes a system and method for an author to prepare a course for delivery to students, primarily using drop and drag functionality in a GUI to form graphical flow charts representative of course delivery, preferably where the course is arranged for directed delivery to different students. In addition, the course is further customizable based on individual students' results in portions of the course.

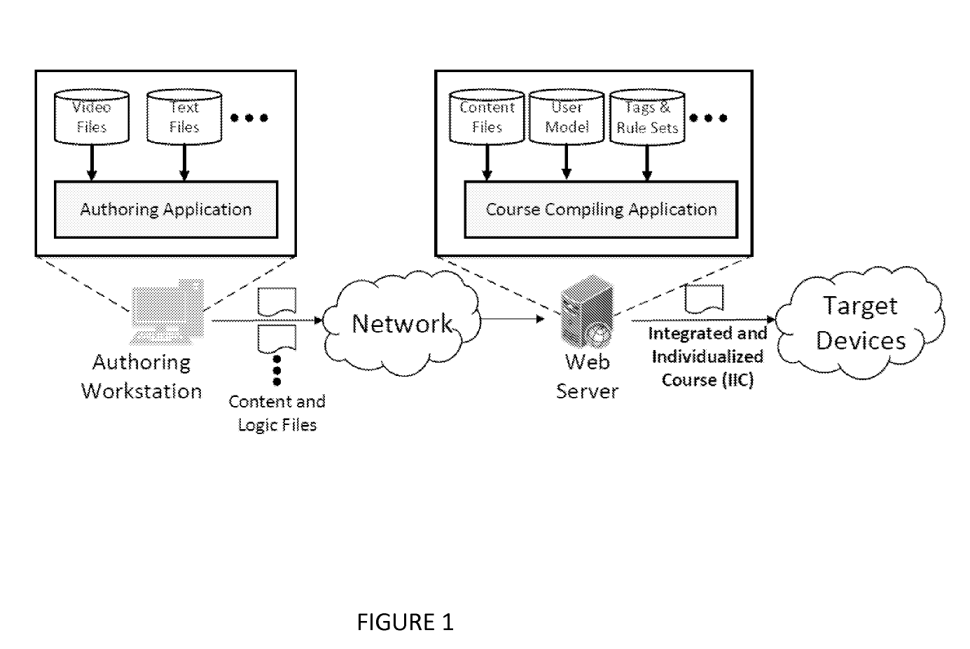

FIG. 1 depicts a schematic diagram of an embodiment of the present invention. The schematic diagram of the embodiment depicts a layout of the various systems involved in the present disclosure. Using this layout, the author creates the course from an authoring workstation 100, which can be any traditional personal or shared computing device with or access to storage (desktop, laptop, etc.). Stored content at or associated with the authoring workstation includes segregated content files which have been created or accessed by the author for a course, and by an authoring application itself. The content files (formats) can include, but are not limited to, video (.mp4), text and assessment (.html, .xml, Microsoft Word .doc, .txt), presentation (Microsoft PowerPoint .ppt), images (.png, .jpg) and audio files (.mp3, .wav), and equivalents, as well as hyperlinks to external content (e.g., link to a Wikipedia page or to a corporate intranet), and are included in the storage of the workstation.

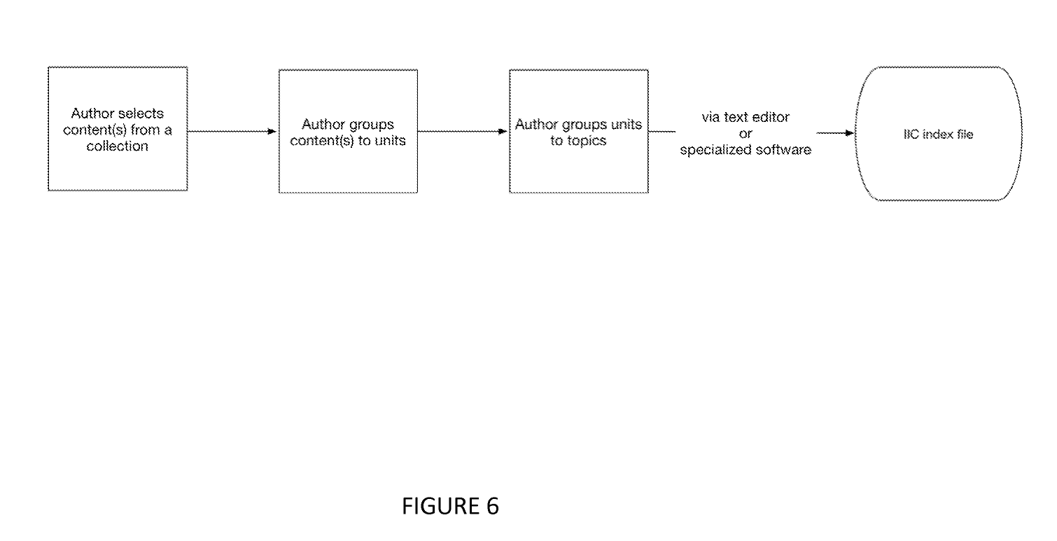

In a typical process of creating linkages for content, the author selects instances of content from a collection and groups them into topics, units, and segments. Such grouping may be automatic, such as by using tagging, or manual, such as by using a GUI and/or drop-and-drag capability. A summary of this process is shown in FIG. 6; here, we make no distinction between units and segments, with the understanding that at the lowest level, segments can be defined to encapsulate one or more content files. Note that this process can either be done manually by writing an IIC index file (explained below) using a text editor, or by using specialized software with a user interface where the user drags and drops representations of the content to organize them. This software then produces the index file for the IIC.

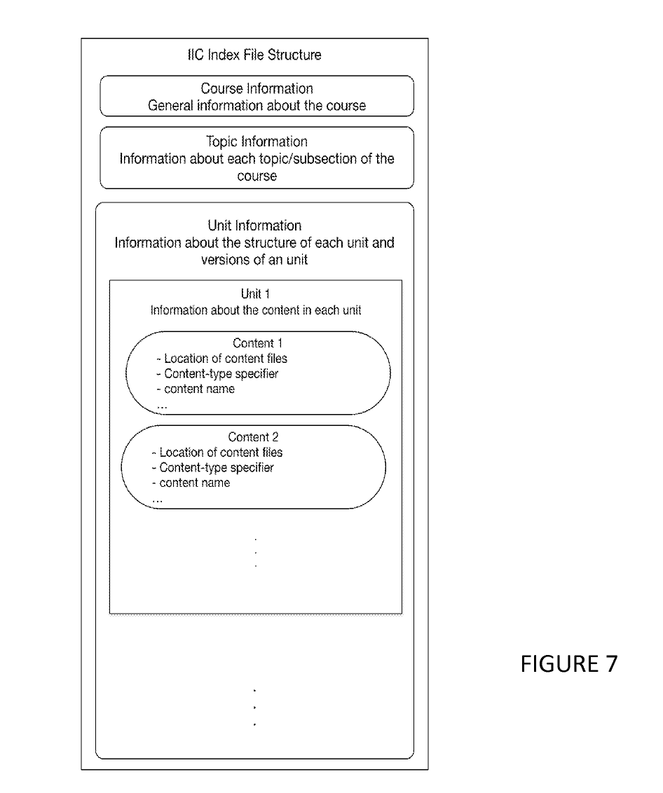

The IIC index file reflects the structure of a course and is created following predefined rules and can have any of different types of formatting (e.g. JSON, XML). FIG. 7 shows one possibility for the structure of this file (again, without distinguishing units and segments). In this embodiment, the structure is hierarchical: general information about a course is added first, which includes, but is not limited to, the course's name, the names of the author, version information, tags and keywords. Second, information about the different topics of the course is added. The topic information contains, but is not limited to, the unit's name, subtitle, preview images, tags and keywords. Third follows information about each unit of the course. The information for every unit contains, but is not limited to, detailed information about every piece of content such as the location/path/URL of the content files, and a specifier which identifies the type of content and the content's name. Furthermore, the unit-level information can contain information about quiz questions that might be associated with certain types of content or the units themselves.

The process shown in FIG. 6 can involve additional steps such as tagging (either manually or algorithmically) the units and topics. In the present invention a system may be implemented which automatically creates units by analyzing the content algorithmically, to determine the subjects of content, thereby organizing/linking instances of content with the same subjects or similar subjects into units and/or topics. These types of algorithms would analyze content for this purpose, and also tags that have been assigned to the content manually or by algorithms. In an additional step, the author refines the linkage of content, by using software that allows the author to re-define linkages through a user interface.

Using the authoring application, an author creates a “base” IIC by amassing content files to be viewed in a particular sequence. That is, a base IIC includes content files and linkages from one file to another file. At times, the base IIC may include display instructions such as concurrent display of a video and text. Once the author has created the IIC with the authoring application, in a preferred embodiment, the resultant content and logic files may be sent across a network to a web server, as shown in FIG. 1. The files might be further processed and optimized on the web server. These logic files include specifications of content tagging and adaptation rule sets (i.e., by which the course will be adapted), each of which are created during the authoring phase.

The present invention places virtually no limitation on the types of adaptation rules that can be constructed, other than that they must relate to either the input measurements directly, or to the user model that is updated based upon these inputs. As such, the rule sets may be complex, may be applied on a segment-by-segment basis, and/or may be based on user model as applied to a student. Recall that the system of the present invention implements a user model and generally tracks the evolution of the user's proficiency, learning style preferences, and/or more generally his/her usage in one or more of the segments, for each of the learning features that the author has specified so as to potentially adjust delivery to that student and potentially adjust the overall model. The methods by which this model can be updated are discussed below. Each rule serves as a constraint on either the sequencing of one segment to another, or on the modification of individual content files within a segment. For example, a rule could informally be “transition from segment 2 to segment 3 if the user model for learning feature 2 is less than 0.5”, “show video A instead of video B in segment 6 if the user has skipped back on videos more than seven times”, or “repeat segment 4 if the user received zero points on the assessment and spent less than 30 seconds total in the segment”. More generally, the author can specify both a lower and an upper bound on a value (or on multiple values) for a rule, such that the value (either an input or a user model dimension) must be greater than the lower bound and less than the upper bound. These bounds can be represented conveniently as multidimensional vectors, where each dimension of said vector contains the lower and upper bound of the corresponding feature number. These vectors are referred to as transition vectors herein.

When a rule is executed, it is considered to be valid if its constraints are met, and invalid if its constraints are not met. For example, in the last example above, if the user received zero points and spent 2 minutes in the segment, then this rule would be invalid and the user would not repeat segment 4. Rules can be executed at the end of a segment, after the measurements have been collected, which is how it is presented here; note, however, that in a preferred embodiment of the present invention, analysis can be called upon while the user is within a segment as well, at a point in time specified by the author. In summary, for any particular student, a user model is employed where transitions are based on conformance to a set of rules; if no rule is met, the default user model remains unchanged at least at that relevant point in time.

Considering all of the rules to be executed at the end of a segment, there are three possibilities. The first is that none of the transitions are valid; to avoid this problem, the author will always designate one of the rule outputs to be the default or the system of the present invention establishes a default. The second is that there is exactly one valid rule, which would be executed accordingly. Finally, there could be two or more valid rules; to prevent this the author can be sure to specify a set of mutually exclusive constraints. Alternatively, the present invention can offer rule set checking functionality, which would determine whether or not exactly one of the rules is valid at each point. This could be done in a number of ways, such as exhaustively testing all possible values that the variable in question could take up to the present point, and testing whether or not there is always exactly one valid constraint. If this issue arises in practice, though, an easy solution is for the system to make a random selection across all of the valid rules.

For purposes of rendering the course and ultimately delivering it to users, a web server (or equivalent) stores each of these rules, among other elements, in a file format compatible with the web server for use in developing and executing the authoring tool.

In other words, when a student enrolls in a course, data regarding the student are used to select an applicable user model, and the delivery of content is identified based on the user model, subsequent student performance, and applicable rules.

The present invention must contain machine learning algorithms for mapping the inputs collected from the system to updating the user model. Machine learning is a branch of artificial intelligence (i.e., intelligence exhibited by software) where there is an inductive step in which the algorithm learns from and is augmented by the data. In this context, the algorithms for the authoring tool include both those required to process the data from the IIC, and those to modify the user model on the appropriate learning feature dimensions specified by the author.

The set of inputs collected by the IIC that can be used for this purpose are entirely dependent on the type of content that the author has integrated into the IIC, and the present invention places no limitations on the types of inputs. In an embodiment, a set of inputs collected about each user through the IIC application includes, but the inputs are not limited to, the following:
Play, pause, stop, fast forward, rewind, playback rate change, exit, and any other video player events, as well as corresponding timestamps, durations, and any other information that specifies user interaction with a video player.
Page, font size, exit, and other text viewer events, as well as corresponding timestamps and durations that specifies user interaction with a text viewer.
Slide change, completion, button press, and other events triggered from viewing a set of slides, as well as corresponding timestamps and durations that specify user interaction with a presentation viewer.
Position and length of highlights placed on video or text at specific locations, or on a particular slide, where the video length is measured in time of video and the text length in number of objects from the starting position.
Position and content of bookmarks placed on video or text at specific locations, or on a particular slide.
Position and content of notes taken on video or text at specific locations, or on a slide, as well as whether these notes were either shared publically, shared with a specific set of users, or not shared.
Information on each post made in discussion forums, including its content, whether it was meant as a question, answer, or comment, and the number of up-votes it received from other users or the instructor.
Submission, time spent, and number of attempts made for each assessment submitted, as well as the points rewarded if the assessment was machine gradable.

The last item here regards performance inputs; the remaining items are behavior-based inputs.

From these inputs, one simple machine learning algorithm for updating the user model is a score tracking system, where each answer choice in an assessment is associated with a number of points (possibly binary) for one or more features. This approach may be desirable because tests are sometimes considered to be the most reliable source of evidence that a user has gained knowledge in a respective learning feature.

Beyond this, there are a number of algorithms (discussed in the following paragraphs) that can be leveraged by the present invention to map the inputs to the user model, and even to define what the feature set will be in the first place. One such algorithm is matrix factorization, which is a subset of collaborative filtering. This technique can be applied to educational data to extract latent feature sets. In its simplest form, matrix factorization (in this application) models each user and assessment in terms of a vector of a specified number of dimensions, and seeks to minimize the error in predicting the scores of each user on each quiz, optimized over all observed user-quiz pairs. With each new segment that a user has completed, the user model would continue to be updated accordingly, based on the new data.

But matrix factorization only considers structure within the performance data itself; other algorithms exist that can be used to include the behavior-based inputs specified above, among others. For example, regression and/or classification algorithms can be applied to determine correlations between these inputs and the performance of a user, across different segments and/or units of the course. In this way, the behavioral inputs are used to reinforce the updates to the user model. An example is factorization machines, where each user-quiz pair is represented as a vector. The set of dimensions comprising this vector contains all the possible attributes of the pair, which can take binary values, such as identifying the particular user, or real values, such as the percentage of the corresponding video the user completed.

As an example of a correlation-based method, an algorithm could relate a user's video behavior to her performance with a given learning feature, which is accomplished by finding and updating the correlation coefficient between performance on assessments the user has completed and the time the user spent watching the videos corresponding to these assessments for each feature. A composite performance measure, combining quiz scores with the video-watching behavior scaled by this correlation coefficient, is updated each time a user completes a segment. There are two potential benefits of having these two measures of performance. First is that performance can be updated even if the user has chosen to skip an assessment (i.e., by using the watching behavior score), which will be particularly useful in a situation like Massive Open Online Courses (MOOCs) where quiz responses may only be optional. (A MOOC is comprised of online educational courses taken by multitudes of users who often have access to online lectures, problem sets, and discussion forums.) Second is that with additional information, the effect of the noise associated with guessing correctly and slipping behavior (i.e., answering incorrectly when the user actually knows the information) can be reduced.

Furthermore, clustering algorithms could lead to groupings of users that define realistic feature sets.

To render the course from the content and logic files, the web server in FIG. 1 contains a course compiling application, which we may refer to as an IIC compiler. The IIC compiler will assign unique identifiers to each segment of content, tag, and adaptation rule. It generates the sequences and associations between the files, and renders a resulting IIC container file in a proprietary format compatible with end user devices. Using the files that contain the adaptation rule sets described above, instructions are created and stored in a database, which are then used to determine exactly how the content is to be adapted on a user-by-user basis. This IIC container file is encapsulated within the IIC user interface (specified by the course provider), which the target devices obtain, display, and populate with content as specified by the course logic and unique identifiers that are also contained in the file. In a preferred embodiment, some of the content files are contained in the IIC file itself, while others (i.e., videos) would be streamed directly or indirectly from the server, and some may be cached on an end user device as needed or desired.

In another embodiment of FIG. 1, the authoring application resides on a web server and is delivered as a web application to the authoring workstation, which eliminates the need for permanent local storage. In this case, the application is accessed through a web browser (e.g., Safari, Firefox, or Chrome), and the content is uploaded to the web server initially, which would also allow the author to work from multiple workstations.

To begin the process of creating an IIC, the author loads all of the content documents that have been created for the course into an authoring application. In a preferred embodiment, each of these is delivered to a repository that is directly accessible from the main screen (GUI) of the application. An embodiment of the main GUI display of the application is depicted in FIG. 2; here, the files appear on the right side of the display, and each of them are given a unique identifier (e.g., Video 2 is the second video file uploaded).

The author may choose any of the content files and open each in a corresponding editor, typically running on a server. This editor has different functionality for different types of content. For example, it supports editing tasks such as cutting, splicing, and recording for video and audio formats. For text and assessments, it will function as a word processor with support for text, image, and math equation editing. Tools to modify other types of content, such as slide shows, are also available. Through the editor, an author can modify, merge, and/or split existing files as needed, as well as copy and paste content from other applications running on the workstation (e.g., other word processors or image editing software).

Consequently, the editor of the present invention allows an author to edit existing content to customize a course or customize to a type of student.

The author then copies (or equivalent) these edited course files to construct the framework of the IIC through the main GUI editor depicted in FIG. 2. In a preferred embodiment, this GUI-based editor will feature drag and drop functionality of the different course elements. In piecing the content together, the author can divide the course into a number of units, which are sequenced horizontally as shown in the window shown in FIG. 2. These could, for example, correspond to different course topics. Each unit can be further divided into a number of versions (sequenced vertically), which could be used to distinguish between different styles or difficulties of the material in a unit. We refer to a given version of a given unit as a segment of content.

To create a new content segment, within a preferred embodiment the author simply selects a new segment, represented as a rectangle in FIG. 2, and drags it to where it will exist in the course structure. Then, the course files for the segment must be specified, for which the author can simply drag the files from the repository into the segment.

If the author chooses to have at most one of each file type in each segment, then the ordering of the files within the rectangles in FIG. 2 is irrelevant, since there will be a one-to-one correspondence between these and areas of display on the user interface of the target device. Each of the segments in FIG. 2 is depicted in this way; for example, the first version (top) of the second unit consists of Text 2, Audio 1, and Presentation 1. In general, though, the target device may allow more than one file type for each segment; in which case, the author needs to place each group of files in a logical order of presentation (e.g., Group 1 is Video 1, Text 1, Presentation 1, and Assessment 1, followed by Group 2 which is Video 2 and Assessment 2, and so on), so that the IIC can be rendered in the proper order for display on the target device, in a manner consistent with the user interface specified by the course provider.

Within a segment, the present invention includes the ability to tag content files with learning features of the course that they correspond to. These learning features are the dimensions by which the course is adapted, and are author-specified. In a preferred embodiment of the present invention, the author has the freedom to come up with any designation(s) for learning features; for example, the author may encapsulate key concepts covered in the material (e.g., in a course on arithmetic, they could be “addition”, “subtraction”, etc.) and/or different learning styles (e.g., “visual”, “verbal”). We refer to these as content features and learning style features, respectively. These embedded tags are usable by the system of the present invention to determine matable (or associable) content files, and to aid an instructor in sequencing content files for individuals, among other reasons. As discussed, the dimensions of a user model can be thought of as measures of a user's competence with (for content feature), or tendency towards (for learning style feature), specified learning features for the course. The user model is ultimately used to determine the specific adaptation for the IIC by comparing it with the adaptation rule-set specified by the author.

In a preferred embodiment of the present invention, the tagging process within a segment consists of at least two parts. First is to specify in a content file of the tags, so that the user model can be updated based on behavior noted at the respective locations for the corresponding features. That is, an instructor can tag an entire content file and separately and distinctly tag portions of the file. For example, in a video file which may run ten minutes, the portion from 2:05 to 3:15 may have one tag, the portion from 2:55 to 7:00 may have a different tag, and so on. In the context of the present invention, the tags are used to identify some or all portions of a content file with topical elements and for further characterization (such as but not limited to a degree of difficulty). Second is to specify the rules that determine how the content within a tag will be adapted depending on the current user model. As an example, FIG. 3 (tags shown below) shows tagging for a video file and an assessment within a segment. For the video, the author adds feature tags to specific play position intervals, and in a preferred embodiment, the author and a student are each able to view the content of the video as the position on the seek bar is changed. Overall, in FIG. 3, the author has added 6 tags and 3 features to the video in this example, where each tag is in the form of a rectangle and specifies a length of video for which a learning feature is present. Features can appear in multiple locations throughout a content file; therefore, multiple tags may specify the same feature. Likewise, multiple features may occur within a single location; therefore, more than one feature can be specified by the same tag, though not depicted in the figure.

Note that the tagging process for other forms of content works similarly to that for videos; for textual material, the only difference is that tags are specified for blocks of text, rather than intervals of video, as shown in the left side of FIG. 4. Here, a block of text can be any type or length of content in a text document: one or more lines, paragraphs, individual words, images, tables, and/or equations. For machine-gradable, multiple choice assessments, each answer choice can be tagged with corresponding features and, for example, be assigned a number of points that a user will be awarded for selecting it, as shown in the right side of FIG. 3; one can imagine that for certain types of questions (i.e., those with multiple parts), each answer choice may have multiple different features.

With the tags in place (identifying content and portions of content), the user model can be updated based on a user's behavior. The next step is content adaptation—that is, to specify how the content within a segment is adjusted based on a user model, through a series of adaptation rules. Each rule requires specification of the tag of content to be adapted, the type of rule, and the conditions on the user model required for the rule to be executed. In a preferred embodiment of the present invention, an author has at his/her disposal a wide range of content adaptation rule types, such as (but not limited to) emphasizing, collapsing, expanding, and replacing:

With replacing, specific pieces of content within a content file (e.g., sections of a video, individual paragraphs, equations, or images) can be replaced with others. For instance, one video may contain more images and less text than another, which is desirable for users that exhibit this type of learning style preference. Of course, if there are many replacements, it may be more logical for the author to create an entirely different segment.

With collapsing/expanding, content can also be collapsed or expanded depending on the user model. For struggling students this can be useful to elaborate on explanation details/revision and hide advanced material. For advanced students, elaborate explanations can be hidden, and advanced material covered more thoroughly.

With emphasizing, content pertaining to learning features that a user possesses strengths/weaknesses in can be emphasized. For text, this includes modifying the font/color or highlighting. This helps a student to quickly focus on these areas for reinforcement or improvement.

For instance, suppose an author wants to specify a rule that will draw attention to a key block of text if the user is determined to be struggling with the material for content learning Feature 2. In the left side of FIG. 4, we show a preferred embodiment in which the author is able to select the tag for the block and create an “emphasize” rule on Feature 2, choosing to color the text “red” if the current user model indicates low proficiency on that feature (for purposes of illustration, we stick to “high” and “low” as a qualitative interpretation of the user model feature values, but more generally they can take real values, e.g., having the proficiency be greater than or less than a certain real number). The result is depicted visually as a “rule box”, with an arrow pointing to it from the respective tag. As another example, suppose an author wants to specify a rule that will hide a chunk of video he/she has deemed as supplementary material if the user is showing tendency to focus on material for learning style Feature 3 but not for learning style Feature 4 (presumably then, this chunk of video is presented in a style consistent with Feature 3, which opposes that of Feature 4). In the right side of FIG. 4, we show a preferred embodiment in which the author specifies a “collapse” rule corresponding to this tag, which is conditioned on the user model for these two features.

Adaptation occurring within a segment in the way, through content tags, is supported and is known as presentation adaptation. In the present invention, navigation adaptation, which occurs between segments, is also supported. Presentation adaptation refers to a content file within a segment being modified in some way (e.g., through replacing, emphasizing, collapsing and/or expanding rules as discussed above), whereas navigation adaptation refers to the sequencing that occurs between segments (e.g., moving from segment 1 in unit 1 to segment 2 in unit 2, rather than to segment 1 in unit 2).

Navigation adaptation is the type of adaptation represented logically by the arrows in the GUI in FIG. 2, which denote the potential transitions from segment to segment. There are a number of ways that the author can specify these arrows. In one embodiment, the arrows are placed into the transition diagram through drag and drop functionality, in the same way as the segment blocks themselves. In another embodiment, the author could enter the starting segment and ending segment for each arrow as rows in a table, which could be processed by the workstation. In the case where there is only one possible transition from a segment, only one outgoing arrow is placed, and there is no navigation adaptation or transition logic to be specified. But in the majority of cases, the author needs to define many potential transitions, which requires a specification of a set of rules that determine the next segment from the available outbound links. These rules will be conditioned on the user model in the same way as for presentation adaptation. More specifically, considering all of the rules to be executed at the end of a segment, there are three possibilities. The first is that none of the transitions are valid; to avoid this problem, the author will always designate one of the rule outputs to be the default. The second is that there is exactly one valid rule, which would be executed accordingly. Finally, there could be two or more valid rules; to prevent this, the author can be sure to specify a set of mutually exclusive constraints.

The system of the present invention can determine validity automatically. Alternatively, the present invention can offer rule set checking functionality, which would determine whether or not exactly one of the rules is valid at each point. This could be done in a number of ways, such as exhaustively testing all possible values that the variable in question could take up to the present point, and testing whether or not there is always exactly one valid constraint. If this issue arises in practice, though, an easy solution is for the system to make a random selection across all of the valid rules.

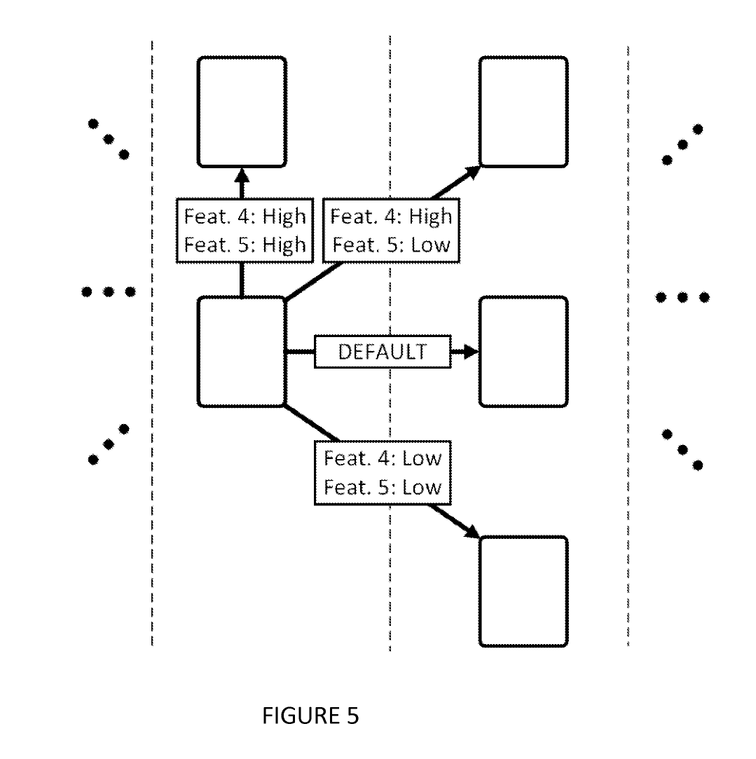

In a preferred embodiment, the rules for navigation adaptation will be specified directly from the main GUI in FIG. 2, by selecting the corresponding arrows and adding feature conditions. An example of this is shown in FIG. 5, where the segment in question has four outgoing links, and the conditions on the links relate to different levels of proficiency on Features 5 and 6. In a preferred embodiment, the author will be able to leave one outgoing link as the default transition (as in FIG. 5), which will be executed if the conditions on the remaining links are not satisfied. This is especially useful since it can be difficult to come up with a set of non-conflicting, mutually exclusive conditions especially as the number of features to be conditioned on becomes large. To this end, a preferred embodiment of the present invention will include rule checking functionality to ensure that there is exactly one valid transition from each segment for each possible user model at a given point in the course.

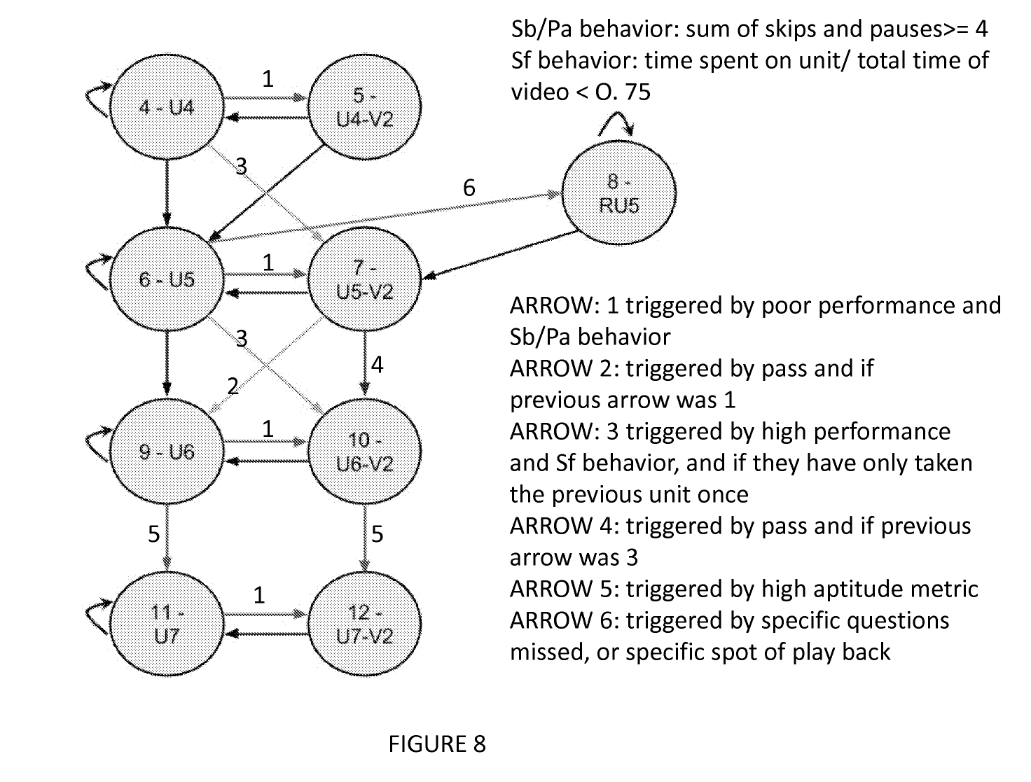

It is important to mention that the visuals depicted in FIGS. 2-5 represent only one embodiment of potential GUI screens for the authoring application. There are many possibilities for this, and the present systems and methods make no claims to any specific interface design. To this end, another example of a visual representation is provided in FIGS. 8A and 8B. Here, the arrows transitioning between the different segments of the IIC represent the different rule sets specified by the author for purposes of adaptation. The color of each arrow dictates the rule that must be satisfied to execute this specific transition. Again, the GUI shown in FIGS. 8A and 8B is a direct translation of how the user will navigate through the IIC, with each arrow defining its own behavioral trigger or rule.

Finally, in a preferred embodiment of the authoring application, a revision control system would be included that records all modifications and additions that the author makes to the content, and to the adaptation rule sets, over time. This will enable an author to revert back to older versions of the IIC at any time.

1. A method for a processor with access to stored content to organize and customizably deliver learning materials to a student, comprising the steps of:
obtaining a plurality of learning modules, each said learning module comprising student-downloadable learning materials for a syllabus topic;
tagging each learning module with a tag indicative of said syllabus topic;
forming a sequence map of said learning modules and potential transitions between learning modules, each said transition assigned a transition vector based on said tags and potential student performance in said course;
calculating at least one preferred navigation path through said map based on known learning attributes of a set of students;
delivering a learning module to a student based on said preferred path;
developing a user-specific path based on assessing said student's performance in delivered learning modules; and
determining a subsequent module for delivery to said student based on comparing said student's performance to said transition vectors;
wherein each learning module comprises at least one of text, image, video, or audio content.

2. The method of claim 1, wherein said user model is amended based on tracking student durations in watching learning modules comprising video.

3. The method of claim 1, where a student's performance is scored and said score is used in determining the next learning module for said student.

4. The method of claim 3, where said user model is used to amend the preferred path.

5. The method of claim 3, where said user model is amended at least in part on student responses to questions delivered in learning modules.

6. The method of claim 1, where said tagging is based on analysis of the audio or textual content of the learning module.

7. The method of claim 1, where said tagging is based on analysis of the visual content of each learning module.

8. The method of claim 1, wherein said tag represent at least one of content identification and complexity.

9. A system for determining a delivery sequence of learning modules to a particular student based on scoring student performance, comprising:
a data store for storing learning module content and
a processor;
wherein said processor is configured for
tagging and organizing a plurality of learning modules for a course, each said learning module comprising student-downloadable learning materials for a subset of the course and comprising at least one of text, images, video, or audio content;
arranging possible delivery sequences of said learning modules by relating each tag to a syllabus;
forming a map of learning modules and potential transitions between said learning modules by assigning values for each transition, said values assigned based on a likelihood of being the next deliverable learning module for a student;
establishing a preferred navigation path through said map based on said values;
delivering a first learning module to the student;
scoring student performance in said learning module;
comparing a student score to said values; and
customizing the navigation path for said student based on said comparing; and
delivering the next module in sequence with the highest likelihood of success.

10. The system of claim 9, wherein said likelihood is related to possible student scores.

11. The system of claim 9, where said processor determines scoring based in part on tracking a student's duration in watching learning modules comprising video.

12. The system of claim 9, wherein said processor repeats the steps of scoring, comparing, and customizing after the student completes a subsequent learning module.

13. The system of claim 9, where said processor determines performance at least in part based on student responses to questions delivered in learning modules.

14. A method for a process with access to a data store to adjust the online delivery sequence of learning modules of a course, adjusted based on student performance, comprising the steps of:
organizing a plurality of learning modules and transitions into a map, each said learning module including student-downloadable learning materials for a subset of a course and each transition including criteria for learning module selection based on learning attributes of a group of students;
calculating a preferred navigation path through said map encompassing all syllabus topics; and
adjusting said preferred path for a particular student based on said criteria and on measured student's performance in delivered content in said course;
wherein each learning module comprises at least one of text, image, video, or audio content.

15. The method of claim 14, wherein each of said learning modules is tagged so as to identify content and said tags correspond to a syllabus topic.

16. The method of claim 15, where determining said tags are determined based on an analysis of the audio or textual content of each learning module.

17. The method of claim 14, where said student's performance is based on tracking student durations in watching learning modules comprising video.

18. The method of claim 17, where said student's performance is scored, and said score is used for comparison to transition criteria.

19. The method of claim 18, where said adjusting the preferred path is determined based on a student's score following completion of each learning module.

20. The method of claim 14, where said student performance is determined at least in part based on student responses to questions delivered in learning modules.
